(19) United States
(12) Patent Application Publication
(10) Pub. No.: US 2008/0102740 A1
(43) Pub. Date: May 1, 2008

(54) Pad for Preventing Axial Shift for Use in Grinding of Eyeglass Lens Coated With Fluorine

(76) Inventors: Tohru Nakaya, Nara (JP); Ryo Yamamoto, Nara (JP); Kusutaro Yoshida, Nara (JP)

Correspondence Address: BIRCH STEWART KOLASCH & BIRCH, PO BOX 747, FALLS CHURCH, VA, 22040-0747, US

(21) Appl. No.: 11/883,350

(22) PCT Filed: Feb. 2, 2005
(86) PCT No.: PCT/JP05/01509

§ 371 Date: Jul. 31, 2007

(51) Int. Cl. B24B 9/14; B24B 13/005; B32B 7/12; B32B 27/40

(52) U.S. Cl. 451/390; 451/240; 428/214; 428/355 N

(57) ABSTRACT

A problem to be solved is to provide a pad for preventing axial shift for use in grinding of a eyeglass lens with which it is possible to process a raw lens into a desired profile without causing axial shift even if it is a lens coated with fluorine.

The problem is solved by a pad for preventing axial shift for use in grinding of a eyeglass lens coated with fluorine comprising a laminate containing a first pressure-sensitive adhesive layer, an elastic material layer, an adhesive layer, a resin film and a second pressure-sensitive adhesive layer, the elastic material layer having a thickness of from 0.2 to 3 mm, an elongation of from 150 to 500% and a tensile strength of from 5 to 200 Kg/cm², the adhesive layer having an adhesive strength of from 2 to 100 Kg/25 mm, and the resin film having an elongation of from 50 to 700% and a tensile strength of from 25 to 300 MPa.

### TECHNICAL FIELD

The present invention relates to a pad for preventing axial shift for use in grinding of a eyeglass lens coated with fluorine.

### BACKGROUND ART

Eyeglasses are obtained by grinding side surfaces of a raw lens with lens surfaces having been polished, with a frame profile desired by a user, optionally subjecting to treatment such as chamfering, grooving, ridging (forming a V-shaped surface; YAGEN) and mirror polishing, and fitting it into a frame.

A schematic view of the principal portion of an apparatus for use in the grinding of the raw lens into a desired profile is shown in FIG. 1. In FIG. 1, 1 denotes a raw lens; 2 and 3 denote clamp shafts; 4 denotes a lens holder; 5 denotes a pad for preventing axial shift; 6 denotes a grinding wheel; 6a denotes a groove for forming a V-shaped surface; and 7 denotes a protective film. As shown in FIG. 1, the pad 5 for preventing axial shift is attached to the front surface of the raw lens 1 and then the clamp shaft 2 is pressed against the pad 5 for preventing axial shift via the lens holder 4. On the other hand, on the rear surface of the raw lens 1, the clamp shaft 3 is pressed via the protective film 7. By pressing the clamp shafts 2 and 3, the raw lens 1 is fixed. The lens fixed is grind into a desired profile with the grinding wheel 6. Such an apparatus is disclosed, for example, in Japanese Utility Model Registration No. 2607363 (Patent Document 1).

The above-mentioned pad 5 for preventing axial shift is required to have durability against twist, tension and the like during the grinding of the raw lens 1. The pad for preventing axial shift generally comprises an elastic layer made of an elastic material such as rubber and a fibrous material optionally blended therein, and pressure-sensitive adhesive layers disposed on both sides of the elastic layer. The pressure-sensitive adhesive layers are provided in order to fix the lens holder and the raw lens. Examples of commercially available pads for preventing axial shift include the LEAP PAD series available from 3M.

Patent Document 1: Japanese Utility Model Registration No. 2607363

### DISCLOSURE OF THE INVENTION

### Problem to be Solved by the Invention

As the material of a lens, materials such as glass, polycarbonate resin, acrylic resin, urethane resin, and the like are known. In addition to such materials, various materials have been proposed. Further, lenses having surfaces coated with fluorine have recently been proposed for improvement in scratch resistance.

Such fluorine-coated lenses cannot be fixed firmly with conventional pads for preventing axial shift.

### Means for Solving the Problem

According to the present invention, a pad for preventing axial shift for use in grinding of a eyeglass lens coated with fluorine comprising a laminate containing a first pressure-sensitive adhesive layer, an elastic material layer, an adhesive layer, a resin film and a second pressure-sensitive adhesive layer, the elastic material layer having a thickness of from 0.2 to 3 mm, an elongation of from 150 to 500% and a tensile strength of from 5 to 200 Kg/cm², the adhesive layer having an adhesive strength of from 2 to 100 kg/25 mm, and the resin film having an elongation of from 50 to 700% and a tensile strength of from 25 to 300 MPa.

### Effect of the Invention

Using the pad for preventing axial shift for use in grinding of a eyeglass lens coated with fluorine of the invention, it is possible to process even a raw lens coated with fluorine into a desired profile without causing axial shift.

### BRIEF DESCRIPTION OF THE DRAWING

FIG. 1 is a schematic view of the principal portion of an apparatus for use in grinding of a raw lens into a desired profile.

### EXPLANATION OF THE SYMBOLS

1 Raw lens

2, 3 Clamp shaft

3 Lens holder

5 Pad for preventing axial shift

6 Grinding wheel

6a Groove for forming a V-shape surface

7 Protective film

### BEST MODE FOR CARRYING OUT THE INVENTION

The pad of the present invention for preventing axial shift for use in grinding of a eyeglass lens coated with fluorine (hereinafter, referred simply to as a pad) comprises a laminate containing a first pressure-sensitive adhesive layer, an elastic material layer, an adhesive layer, a resin film and a second pressure-sensitive adhesive layer. The pad is used in a manner that the elastic material layer is located on the clamp shaft side and the resin film is located on the eyeglass lens side.

In the pad, the elastic material layer has a thickness of from 0.2 to 3 mm, an elongation of from 150 to 500%, and a tensile strength of from 5 to 200 Kg/cm². Here, the elongation and the tensile strength mean values measured in accordance with JIS K6767 (A method). A case where the thickness is less than 0.2 mm is undesirable because a scratch or crack will be formed in the lens. A case where the thickness is greater than 3 mm is undesirable because an axial shift will occur. A more desirable thickness is from 0.3 to 2 mm. A case where the elongation is less than 150% is undesirable because lifting-off or peeling-off will occur on the surface of the lens. An elongation greater than 500% is undesirable because it will cause an axial shift. A more desirable elongation is from 150 to 450%. A tensile strength less than 5 Kg/cm² is undesirable because it will cause an axial shift. A case where the tensile strength is greater than 200 Kg/cm² is undesirable because lifting-off will occur on the surface of the lens. A more desirable tensile strength is from 5 to 180 Kg/cm².

The material which can be used as the elastic material layer is not particularly restricted if it is a material satisfying the above-mentioned thickness, elongation and tensile strength. Examples include rubber-based resin, acrylic-based resin, polyurethane-based resin and polyolefin-based resin. Further, the elastic material layer may be a foam layer of these resins. Specifically, examples of the rubber-based resin include the CALSOFT series (rubber-based resin composed resin derived from 1,2-polybutadiene as main component) available from Takiron Co., Ltd. and examples of the polyolefin-based resin include the VOLARA series available from Sekisui Chemical Co., Ltd. In particular, the CALSOFT series, which is a foam layer of a rubber-based resin, is preferred.

In order to increase the adhesiveness and tackiness with the adhesive layer and/or the first pressure-sensitive adhesive layer, the surface of the elastic material layer may have been provided with corona treatment, anchoring agent treatment, and the like.

The resin film has an elongation of from 50 to 700% and a tensile strength of from 25 to 300 MPa. The elongation and the tensile strength mean values measured by methods the same as that of the elastic material layer. A case where the elongation is less than 50% is undesirable because lifting-off or peeling-off from the surface of the lens will occur. An elongation greater than 700% is undesirable because it will result in occurrence of an axial shift. A more desirable elongation is from 50 to 650%. A tensile strength less than 25 MPa is undesirable because it will result in occurrence of an axial shift. A tensile strength greater than 300 MPa is undesirable because it will result in occurrence of an axial shift. A more desirable tensile strength is from 30 to 25 MPa.

The thickness of the resin film is not particularly limited, but it is typically from 20 to 100 μm.

The material which can be used as the resin film is not particularly restricted if it is a material satisfying the above-mentioned elongation and tensile strength. Examples include films of polyester resin, polyolefin-based resin or polyurethane-based resin. Among these, polyester resin film is preferred. Specifically, the LUMIRROR series available from Toray Industries, Inc. can be used.

In order to increase the adhesiveness and tackiness with the adhesive layer and/or the first pressure-sensitive adhesive layer, the surface of the resin film may have been provided with corona treatment, anchoring agent treatment, and the like.

Next, the adhesive layer has an adhesive strength of from 2 to 100 Kg/25 mm. The adhesive strength means a value measured in accordance with JIS Z1522. A case where the adhesive strength is less than 2 Kg/25 mm is undesirable because cohesive failure will occur in the adhesive layer. A case where the adhesive strength is greater than 100 MPa/25 mm is undesirable because cracks will be formed in the adhesive layer. A more desirable adhesive strength is from 2 to 80 Kg/25 mm. The thickness of the adhesive layer is not particularly limited, but it is typically from 10 to 200 μm.

The adhesive layer is not particularly restricted if it is made of a material satisfying the above-mentioned adhesive strength. Examples include polyurethane-based adhesive and acrylic-based adhesive. Specifically, examples of polyurethane-based adhesive include an adhesive composed of POLYBOND AY-651A (produced by Sanyo Chemical Industries, Ltd.) and CORONATE L-55E (produced by Nippon Polyurethane Industry Co., Ltd.) and examples of acrylic-based adhesive include an adhesive composed of RIKIDYNE AR-2412 (produced by VIGteQnos Co., Ltd.) and CORONATE L-55E.

From the viewpoint of more effective prevention of axial shift, the pressure-sensitive adhesive layer preferably has an adhesive area as wide as from 15 to 80% of the area of a lens surface after grinding. A case where the adhesive area is less than 15% is undesirable because an axial shift will occur. A case where the adhesive area is greater than 80% is undesirable because a surface coating agent will be detached. A more desirable adhesive area to the lens surface is from 20 to 75%.

The first pressure-sensitive adhesive layer and the second pressure-sensitive adhesive layer are not particularly restricted and layers of conventional pressure-sensitive adhesives may be used. The pressure-sensitive adhesive constituting the first pressure-sensitive adhesive layer preferably is a pressure-sensitive adhesive which does not peel off from the lens holder during grinding of the eyeglass lens, but can be easily removed after the grinding. On the other hand, the pressure-sensitive adhesive constituting the second pressure-sensitive adhesive layer preferably is a pressure-sensitive adhesive which does not peel off from the eyeglass lens during grinding of the eyeglass lens, but can be easily removed after the grinding. Specifically, it is desirable to use a layer of an acrylic or rubber-based pressure-sensitive adhesive as the first pressure-sensitive adhesive layer. On the other hand, it is desirable to use a layer of an acrylic or rubber-based pressure-sensitive adhesive as the second pressure-sensitive adhesive layer.

The thickness of the first pressure-sensitive adhesive layer and that of the second pressure-sensitive adhesive layer are typically from 15 to 80 μm and from 15 to 80 μm, respectively. The adhesive strength of the first pressure-sensitive adhesive layer and that of the second pressure-sensitive adhesive layer are preferably from 5 to 30 N/25 mm. The adhesive strength means a value measured by a method the same as that of the adhesive layer.

It is desirable that the first pressure-sensitive adhesive layer and the second pressure-sensitive adhesive layer be covered with a releasing paper and/or releasing film before use. The releasing paper and releasing film are not particularly restricted and any conventional releasing papers and releasing films can be used.

The pad of the present invention may have any shape as long as it can prevent axial shift. For example, its plane shape may be any shape, e.g. circle, oval, polygon such as triangle and quadrangle, and irregular shape. The size of the elastic material layer and that of the resin film may be the same or different. Further, in order to increase the releasability of a used pad from the eyeglass lens and the lens holder, a tab of the elastic material layer and/or the resin film provided with no pressure-sensitive adhesive layer may be formed. The pad is attached around the focus of the eyeglass lens. In order to render alignment at the time of attaching easy, it is desirable to form an opening in the central portion of the pad.

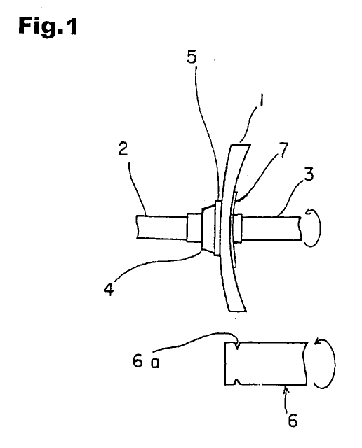

The following is a method of grinding the eyeglass lens in a case where the pad of the present invention is used, for example, in the apparatus shown in FIG. 1. First, the pad 5 for preventing axial shift is attached to the front surface of the raw lens 1 and then the clamp shaft 2 is pressed against the pad 5 for preventing axial shift via the lens holder 4. On the other hand, on the rear surface of the raw lens 1, the clamp shaft 3 is pressed via the protective film 7. By pressing the clamp shafts 2 and 3, the raw lens 1 is fixed. The lens fixed is ground into a desired profile with the grinding wheel 6. According to demand, the lens is subjected to treatment such as chamfering, grooving, ridging (forming a V-shaped surface; YAGEN) and mirror polishing. When the pad is then peeled off from the resulting eyeglass lens, the eyeglass lens with a desired profile can be obtained.

### EXAMPLE 1

The elastic material layers, adhesive layers and resin films of the physical property values shown in Table 1 were prepared. Specific sources of the materials are as follows.

(1) As the elastic material layer of sample 1, DSU203 produced by Sheedom Co., Ltd. was used.

As the elastic material layer of sample 2, CC05B produced by Takiron Co., Ltd. was used.

As the elastic material layers of samples 3 and 6, VOLARA IF produced by Sekisui Chemical Co., Ltd. was used.

As the elastic material layer of sample 4, SC15B produced by Takiron Co., Ltd. was used.

As the elastic material layer of sample 5, CC15A produced by Takiron Co., Ltd. was used.

As the elastic material layers of samples 7, 8 and 10, CC10B produced by Takiron Co., Ltd. was used.

As the elastic material layer of sample 9, VOLARA IFN produced by Sekisui Chemical Co., Ltd. was used.

(2) As the adhesive layers, layers made of a polyurethane-based adhesive composed of POLYBOND AY-651A produced by Sanyo Chemical Industries, Ltd. and CORONATE L-55E produced by Nippon Polyurethane Industry Co., Ltd. were used.

(3) As the resin films of samples 1 to 5 and 7 to 9, LUMIRROR T60 #38 produced by Toray Industries, Inc. was used.

As the resin film of sample 6, L6101 produced by Toyobo Co., Ltd. was used.

As the resin film of sample 8, LUMIRROR T60 #25 produced by Toray Industries, Inc. was used.

As the resin film of sample 9, LUMIRROR T60 #75 produced by Toray Industries, Inc. was used.

As the resin film of sample 10, DSU203 produced by Sheedom Co., Ltd. was used.

(4) As the pressure-sensitive adhesive disposed on the elastic material layer side, an acrylic-based pressure-sensitive adhesive composed of AR-2178M-1 produced by VIGteQnos Co., Ltd. and CORONATE L-55E was used.

(5) As the pressure-sensitive adhesive disposed on the resin film side, an acrylic pressure-sensitive adhesive composed of AR-2037 produced by VIGteQnos Co., Ltd. and CORONATE L-55E was used.

TABLE 1

| | | | | | | adhesive | | | | | |
|---|---|---|---|---|---|---|---|---|---|---|---|
| | | | | | | layer | | | | | |
| | elastic material layer | | | | | adhesive | resin film | | | | |
| | | | | tensile | | strength | | | | tensile | |
| sample | | trade | thickness | strength | elongation | (Kg/25 | | trade | thickness | strength | elongation |
| No. | maker | name | (mm) | (Kg/cm²) | (%) | mm) | maker | name | (mm) | (Kg/cm²) | (%) |
| 1 | Sheedom | DSU203 | 0.18 | 310 | 650 | 15 | Toray | T60 | 38 | 225 | 140 |
| 2 | Takiron | CC05B | 0.6 | 23 | 420 | 15 | Toray | T60 | 38 | 225 | 140 |
| 3 | Sekisui | VOLARA | 1 | 17 | 310 | 15 | Toray | T60 | 38 | 225 | 140 |
| | Chem. | IF | | | | | | | | | |
| 4 | Takiron | SC15B | 3 | 4.4 | 280 | 15 | Toray | T60 | 38 | 225 | 140 |
| 5 | Takiron | CC15A | 2 | 3.3 | 300 | 15 | Toray | T60 | 38 | 225 | 140 |
| 6 | Sekisui | VOLARA | 1 | 17 | 310 | 15 | Toyobo | L601 | 40 | 38 | 480 |
| | Chem. | IF | | | | | | | | | |
| 7 | Takiron | CC10B | 1 | 7 | 310 | 15 | Toray | T60 | 38 | 225 | 140 |
| 8 | Takiron | CC10B | 1 | 7 | 310 | 1.5 | Toray | T60 | 25 | 225 | 170 |
| 9 | Sekisui | VOLARA | 2 | 8 | 310 | 15 | Toray | T60 | 75 | 215 | 150 |
| | Chem. | IFN | | | | | | | | | |
| 10 | Takiron | CC10B | 1 | 7 | 310 | 15 | Sheedom | DSU203 | 125 | 31 | 650 |

Next, pads were produced in the following manner using the materials provided in Table 1. That is, a core was prepared by bonding an elastic member and a resin film with an adhesive. It was aged at 40° C. for three days. Pressure-sensitive adhesives were applied to both sides of the core and then releasing films were attached. Thus, a double-stick tape was prepared. It was aged at 40° C. for three days. After the aging, the double-stick tape was punched in a predetermined size. Thus, a sheet for preventing axial shift was prepared.

Using the pad obtained, the horizontal shift angle and the lens conditions after grinding were evaluated. The results are shown in Table 2. The evaluations were conducted as follows. An automatic lens edger produced by TOPCON Corp. was used as a lens grinder. Lines are drawn crosswise at the center of a lens, which is composed of a round piece of plastic and has surfaces coated with fluorine, before grinding. After sticking of a pad with a blocking device (LS-2, produced by Takubo Seiki Seisakusho K.K.), the lens is set in the automatic lens edger (ALE-100DX, produced by TOPCON Corp.) so that one of the lines may become level and ground. After the grinding, a standard lens is put on the ground lens and the angle between the level line of the ground lens and the level line of the standard lens is measured. This angle is called the horizontal shift angle. When the horizontal shift angle is 3° or less, it is considered as being acceptable from the viewpoint of axial shift prevention.

TABLE 2

| | horizontal shift angle | |
|---|---|---|
| Sample No. | (°) | lens condition |
| 1 | — | cracked |
| 2 | 2 | no cracked |
| 3 | 1 | no cracked |
| 4 | 4 | no cracked |
| 5 | 4 | no cracked |
| 6 | 1 | no cracked |
| 7 | 0 | no cracked |
| 8 | 4 | no cracked |
| 9 | 1 | no cracked |
| 10 | 1 | no cracked |

Table 2 shows that a pad comprises an elastic material layer having a thickness of from 0.2 to 3 mm, an elongation of from 150 to 500% and a tensile strength of from 5 to 200 Kg/cm², an adhesive layer having an adhesive strength of from 2 to 100 Kg/25 mm and a resin film having an elongation of from 50 to 700% and a tensile strength of from 25 to 300 MPa has an excellent axial shift prevention effect.

1. A pad for preventing axial shift for use in grinding of a eyeglass lens coated with fluorine comprising a laminate containing a first pressure-sensitive adhesive layer, an elastic material layer, an adhesive layer, a resin film and a second pressure-sensitive adhesive layer, the elastic material layer having a thickness of from 0.2 to 3 mm, an elongation of from 150 to 500% and a tensile strength of from 5 to 200 Kg/cm², the adhesive layer having an adhesive strength of from 2 to 100 Kg/25 mm, and the resin film having an elongation of from 50 to 700% and a tensile strength of from 25 to 300 MPa.

2. The pad for preventing axial shift for use in grinding of a eyeglass lens coated with fluorine of claim 1, wherein the elastic material layer is a foam layer of a rubber-based resin, acrylic-based resin, polyurethane-based resin or polyolefin-based resin.

3. The pad for preventing axial shift for use in grinding of a eyeglass lens coated with fluorine of claim 1, wherein the adhesive layer is a layer of a polyurethane-based adhesive or acrylic-based adhesive.

4. The pad for preventing axial shift for use in grinding of a eyeglass lens coated with fluorine of claim 1, wherein the resin film is a film of a polyester resin, polyolefin-based resin or polyurethane-based resin.

5. The pad for preventing axial shift for use in grinding of a eyeglass lens coated with fluorine of claim 1, wherein the adhesive layer has an adhesive area as wide as from 15 to 80% of the area of a lens surface after grinding.

6. The pad for preventing axial shift for use in grinding of a eyeglass lens coated with fluorine of claim 1, wherein the first pressure-sensitive adhesive layer is a layer of a rubber-based adhesive or acrylic-based adhesive, the second pressure-sensitive adhesive layer is a layer of a rubber-based adhesive or acrylic-based adhesive.
